(19) United States
(12) Patent Application Publication
(10) Pub. No.: US 2008/0206126 A1
(43) Pub. Date: Aug. 28, 2008

(54) Higher than 30% concentration lime slurries, preparation and uses thereof

(76) Inventors: Robert Benson, North Bay (CA); Gerry Kutney, Mississauga (CA); Marc Moreau, Temiscaming (CA); Juraj Strmen, Baie d' Urfe (CA)

Correspondence Address: OGILVY RENAULT LLP, 1981 MCGILL COLLEGE AVENUE, SUITE 1600, MONTREAL, QC, H3A2Y3, omitted

(21) Appl. No.: 11/711,605

(22) Filed: Feb. 28, 2007

(51) Int. Cl. C01F 11/46; C01B 17/96; C09K 3/32; C01D 5/08

(52) U.S. Cl. 423/517; 162/181.2; 252/182.11; 423/555

(57) ABSTRACT

The present invention relates to a composition comprising water, more than 30% w/w of calcium hydroxide, and >0.2% w/w dispersant. A process for preparing such a composition is also disclosed. The composition which can be in the form of a 45-55% concentration lime slurry is particularly useful for converting concentrated ammonium lignosulfonate into calcium lignosulfonate, for converting ammonium lignosulfonate into low sulfate calcium, potassium, sodium, or magnesium lignosulfonate and mixtures thereof, for removing soluble sulfate from concentrated sodium, potassium, ammonium or magnesium lignosulfonate or for treating a weak liquor obtained from the pulp and paper industry.

### TECHNICAL FIELD

The present invention relates to improvements in the field the pulp and paper industry. In particular, this invention relates to compositions or calcium hydroxide slurries having more than 30% w/w concentration, preferably a 40-55% w/w concentration. Processes for preparing these compositions or slurries and their uses are also defined in the present application. More particularly, these compositions or slurries can be used for converting ammonium lignosulfonates into 45-55% w/w solids calcium lignosulfonate solution, sodium lignosulfonate solution, potassium lignosulfonate solution and magnesium lignosulfonate solution and mixtures thereof that preferably contain less than 2.0% w/w sulfate, and for removing soluble sulfates from 45-55% w/w solids ammonium, lignosulfonates eventually containing sodium, and/or potassium, and/or magnesium lignosulfonates.

### BACKGROUND OF THE INVENTION

In acid sulfite pulp mills wood is cooked with acid cooking solutions comprising various bases together with sulphur dioxide dissolved in water. The acid solution Is reacted with wood chips. The cellulose is substantially released as fibers while the other wood components such as lignin, hemicelluloses and extractives are dissolved. The solution is then known as weak liquor. The composition of the liquor depends on the type of chemicals used during the pulping process. In particular, various types of bases can be used during such a process. In order to recover the energy value of the organic portion, the weak liquor is evaporated to about 50% w/w solids concentration. The liquor can then be sold as a dispersant or a binder or it may be burned as fuel. Depending on the nature of base they contain, the liquor can be more or less useful as a dispersant.

In ammonium based sulfite pulping, the weak liquor contains ammonium lignosulfonate. However, the use of such a weak liquor is limited to systems that are below pH 8. In fact, above pH 8, ammonia is released, thereby causing undesirable effects such as bad odors, noxious effects and interaction with other components. These characteristics prevent the use of this kind of liquor in various applications such as concrete admixtures, wherein the pH is above 12. Thus, in order to be able to use the weak liquor in various applications, the ammonia must be removed from the ammonium lignosulfonate. This can be achieved by reacting ammonium lignosulfonates with potassium hydroxide, sodium hydroxide, magnesium hydroxide or calcium hydroxide and converting ammonium lignosulfonate to potassium, sodium, magnesium or calcium lignosulfonate.

Usually, to convert ammonium lignosulfonate to calcium lignosulfonate, lime (calcium hydroxide) is added as a slurry to the concentrated liquor. The resulting product is diluted by comparison with the original raw material because of the water contained in the slurry. This is because lime slurries are rarely used above 30% w/w concentration since they have a higher than 500 cP viscosity. About 10 to 20% lime (wt dry lime/dry lignosulfonate) slurry must be added to the reaction mixture in order to drive off the ammonia. The resulting product, a calcium lignosulfonate solution, has usually a concentration of 40 to 45% w/w total solids. Generally, such a concentration is not sufficient for many applications. Moreover, such concentrations increase the costs related to the transportation calcium lignosulfonate solution. Thus, the use of an evaporator in order to reach a concentration of about 45 to 55% w/w solids is required. Evaporators are expensive both in capital and operating cost. Therefore, it is desirable to find an alternative method for increasing the concentration of the produced calcium lignosulfonate solutions.

Another problem that is often encountered is that in concrete admixtures applications, certain products such as sodium, potassium or magnesium lignosulfonates, (which for example may originate from various pulping processes such as Magnefite, Sodium sulfite or from conversion processes such as ammonium to potassium lignosulfonate) are not compatible with calcium components in admixtures. The reason for this is that these lignosulfonates contain 5-8% (w/w dry basis) of soluble sulfate that will precipitate as gypsum if the lignosulfonate comes into contact with calcium containing admixture. The gypsum settles in storage tanks and induces cleaning costs. Therefore, lower than 2.0% (wt % dry basis) soluble sulfate and 45-55% w/w solids lignosulfonate is desirable.

Another problem with sodium lignosulfonates is that when a solution is cooled to 4-10° C. during storage or transport, 4-15% vol/vol of sodium sulfate precipitates. This sludge has to then be cleaned, encurring costs to user. Therefore, a solution according to the invention is desirable advantageously and not limitatively because it allows to reduce the risk of precipitation of sodium sulfate, and more advantageously and not limitatively at a temperature ranging between 4-10° C.

### SUMMARY OF THE INVENTION

It is therefore an object of the present invention to overcome the above-mentioned drawbacks

All percentage mentioned hereinafter are in weight/weight unless otherwise indicated.

It is also another object of the present invention to provide a process for preparing less than 2.0% w/w sulfate, alkali metal salt of lignosulfonic acid or alkaline earth metal salt of lignosulfonate solutions at low costs

It is also another object of the present invention to provide a process for efficiently preparing less than 2.0% w/w sulfate, alkali metal salt of lignosulfonic acid or alkaline earth metal salt of lignosulfonate solutions having a concentration of solids of at least 45% w/w.

It is also another object of the present invention to provide a process for preparing less than 2.0% w/w sulfate, alkali metal salt of lignosulfonic acid or alkaline earth metal salt of lignosulfonate solutions having a concentration of solids of at least 45% w/w without having recourse to an evaporator.

It is also another object of the present invention to provide solutions of alkali metal salt and alkaline earth metal salt of lignosulfonate having higher than 45 % w/w of solids concentration and less than 2.0% w/w sulfate,

It is also another object of the present invention to provide higher than 30% w/w solids concentration calcium hydroxide slurries or compositions. Advantageously, said calcium hydroxide slurry composition may comprise:

| | | |
|---|---|---|
| calcium hydroxide | >30% | w/w |
| a dispersant, said dispersant being a salt of | ≧0.2% | w/w |
| lignosulfonic acid; | | |
| water | qsp* 100% | w/w |

*qsp means sufficient amount to complete the composition at 100% w/w

Preferably, the calcium hydroxide slurries or compositions may have more than 40% w/w of solids concentration, more preferably between 40 and 55% w/w of solids concentration and much more preferably between 45 and 50% w/w of solids concentration.

It is also another object of the present invention to provide a process for preparing aforesaid calcium hydroxide slurries compositions having a higher than 30% w/w concentration of solids.

It is also another object of the present invention to provide a process for preparing aforesaid calcium hydroxide slurries compositions or a lime slurry composition having a higher than 30% w/w concentration of calcium hydroxide and a viscosity such that it can be easily manipulated.

It is also another object of the present invention to provide a process for preparing aforesaid calcium hydroxide slurries compositions or a lime slurry composition having a higher than 30% w/w concentration of calcium hydroxide and a viscosity such that it can be pumped through conduits or pipes without settling.

According to another particularly preferred aspect of the invention, there is provided a calcium hydroxide slurry composition comprising:
40.0 to 55.0% w/w of calcium hydroxide.
0.2 to 7.5% w/w of a dispersant, said dispersant being a salt of a lignosulfonic acid; and
37.5 to 59.8% w/w of water.

According to another particularly preferred aspect of the invention, there is provided a composition comprising about 42.5 to about 54.8% w/w of water, about 45.0 to about 50.0% w/w of calcium hydroxide, and about 0.2 to about 7.5% w/w of a dispersant. Preferably, said dispersant is an alkali earth metal salt of lignosulfonic acid or an alkali metal salt of lignosulfonic acid, or mixture thereof. More preferably, the dispersant may be selected from the group consisting of sodium lignosulfonate, potassium lignosulfonate and magnesium lignosulfonate.

Applicant has found that the previously mentioned composition can be useful for providing higher than 40% w/w concentration of calcium hydroxide slurries or higher than 40% w/w concentration lime slurries which can be used in various processes in view of their below 500 cP viscosity. This composition can thus permit to obtain higher than 40% w/w concentration lime slurries having a viscosity which is sufficiently low to be poured from a reservoir to another reservoir. It has been found that by adding the dispersant to the composition, it is possible to fluidize the composition so that higher than 40% w/w concentration lime slurries having a lower than 500 cP viscosity can be obtained. This composition having such a dispersant, permits to obtain a higher than 40% w/w concentration slurry which would normally not be usable since its viscosity would be higher than about 2000 cP, thereby rendering their manipulation very tedious. However, in this composition the dispersant considerably fluidizes the lime slurry thereby lowering the viscosity. Thus, the so obtained lime slurry has a higher than 40% w/w concentration of solids and a viscosity which is below 2000 cps, preferably below 1000 cps and more preferably below 500 cP in order to permit easy manipulation and to transfer it from a reservoir to another. In particular, the lime slurry can be pumped through pipes without settling. According to a particularly preferred embodiment of the invention, the composition has a viscosity between 10 and 500 cps.

According to another aspect of the invention, there is provided a use of a composition as defined hereinabove, for preparing a solution of less than 2.0% w/w (dry basis) soluble sulfate lignosulfonate salt selected from the group consisting of calcium lignosulfonate and a mixture of calcium and alkali metal lignosulfonate and/or alkaline earth metal lignosulfonate (preferably sodium and/or potassium and/or magnesium lignosulfonate).

According to another aspect of the invention, there is provided a use of a composition as defined hereinabove for converting an ammonium lignosulfonate solution into a calcium lignosulfonate solution having 45-55% w/w solids concentration.

According to another aspect of the invention, there is provided a use of a composition as defined hereinabove for converting an ammonium lignosulfonate solution into a mixture of calcium and sodium and/or potassium and/or magnesium lignosulfonate having 45-55% w/w solids concentration.

According to another aspect of the invention, there is provided a use of a composition as defined hereinabove for removing soluble sulfates from a solution comprising 45-55% w/w solids lignosulfonate salts selected from the group consisting of ammonium lignosulfonate, sodium lignosulfonate, potassium lignosulfonate, magnesium lignosulfonate and mixtures thereof.

According to another aspect of the invention, there is provided a process for preparing the previously mentioned composition. This process comprises the step of mixing together the dispersant, water and calcium hydroxide.

According to another aspect of the invention, there is provided a process for preparing aforesaid lime slurry having a concentration of solids of at least 30% w/w. This process comprises the step of mixing together water, calcium hydroxide and a dispersant. Preferably, said dispersant may be selected from the group consisting alkali metal and/or alkaline earth metal salt of lignosulfonic acid, or mixture thereof. Preferably the dispersant may be selected from the group consisting of sodium lignosulfonate, potassium lignosulfonate and magnesium lignosulfonate.

Applicant has found that such processes can permit to easily obtain aforesaid compositions or slurries having a higher than 30% w/w concentration of solids.

According to another aspect of the invention, there is provided a process for preparing a solution of less than 2.0% w/w (dry basis) soluble sulfate. These solutions consist of calcium lignosulfonate, or a mixture of calcium lignosulfonate and sodium lignosulfonate, and/or potassium lignosulfonate, and/or magnesium lignosulfonate.

This process comprises the step of reacting an ammonium lignosulfonate solution together with the composition or a lime slurry as defined in the present invention. Alternatively, the ammonium lignosulfonate solution is reacted together with the composition or a lime slurry as defined in the present invention and/or alkali metal hydroxide and/or an alkaline earth metal hydroxide.

According to another aspect of the invention, there is provided a process comprising a step of reacting an ammonium lignosulfonate solution together the composition or a lime slurry as defined in the present invention. Alternatively, the ammonium lignosulfonate solution is reacted together with the composition or a lime slurry as defined in the present invention and/or sodium hydroxide and/or potassium hydroxide and/or magnesium hydroxide The Applicant has surprisingly noted that adding an alkali metal hydroxide before lime, improved ammonia stripping process, gypsum removal process and reduced final product viscosity.

Without being bound to the following theory, the Applicant is thought that ionic crosslinking by divalent calcium ion is reduced by replacing calcium ion in reaction by a monovalent ion such as sodium. Further, it is also thought that precipitated gypsum crystals are larger in size if formed at higher pH, that is if lime slurry is added after the addition of caustic, hence improving gypsum separation from the liquid.

According to another aspect of the invention, there is provided a use of aforesaid higher than 30% w/w solids lime slurry to remove sulfates from magnesium, potassium, ammonium or sodium lignosulfonates. These lignosulfonates may originate from the Magnefite pulping process, from the ammonium sulfite or sodium sulfite pulping process or from the conversion process of ammonium lignosulfonates to potassium lignosulfonates. Preferably, such a use involve a step according to which a magnesium, potassium ammonium or sodium lignosulfonate solution is reacted with a composition or a lime slurry prepared according to a process of the present invention. In this manner, it is also possible to remove soluble sulfates from liquors originating from sulfite (acid, bisulfite or neutral) pulping process, from semi-chemical pulping process such as NSSC (Neutral Sulfite Semi Chemical) or from the Kraft process.

According to another aspect of the invention, there is provided a process for preparing a solution of calcium lignosulfonate optionally in admixture with an alkali metal lignosulfonate and/or alkaline earth metal lignosulfonate (preferably sodium and/or potassium and/or magnesium lignosulfonate), said process comprising a step of reacting ammonium lignosulfonate solution with
0.1-20% by weight of calcium hydroxide slurry composition as defined hereinabove optionally further containing between 0-20% by weight (upper limit included) of an alkali metal hydroxide and/or an alkaline earth metal hydroxide (preferably sodium hydroxide and/or potassium hydroxide and/or magnesium hydroxide); or
optionally 0.1-20% by weight of calcium hydroxide slurry composition and a solution comprising between 0-20% (upper limit included) by weight of an alkali metal hydroxide and/or an alkaline earth metal hydroxide (preferably sodium hydroxide and/or potassium hydroxide and/or magnesium hydroxide).

According to a preferred aspect of the invention, in process defined hereinabove, said ammonium lignosulfonate solution has a concentration of solids of about 45 to about 55% w/w.

According to another preferred aspect of the invention, in process defined hereinabove, said solution of calcium lignosulfonate optionally in admixture with sodium and/or potassium and/or magnesium lignosulfonate has a concentration of solids of at least 35% w/w.

According to a preferred aspect of the invention, in process defined hereinabove, said solution of calcium lignosulfonate optionally in admixture with sodium and/or potassium and/or magnesium lignosulfonate has a concentration of solids of at least 40% w/w.

According to a preferred aspect of the invention, in process defined hereinabove, said solution of calcium lignosulfonate optionally in admixture with sodium and/or potassium and/or magnesium lignosulfonate has a concentration of solids of at least 50% w/w.

According to a preferred aspect of the invention, in process defined hereinabove, said solution of calcium lignosulfonate optionally in admixture with sodium and/or potassium and/or magnesium lignosulfonate has a concentration of solids of about 40 to about 55% w/w.

According to a preferred aspect of the invention, in process defined hereinabove, said solution of calcium lignosulfonate optionally in admixture with sodium and/or potassium and/or magnesium lignosulfonate solution has a concentration of solids of about 45 to about 55% w/w.

According to a preferred aspect of the invention, in process defined hereinabove, said solution of calcium lignosulfonate optionally in admixture with sodium and/or potassium and/or magnesium lignosulfonate has a concentration of soluble sulfate that is less than 2.0% w/w dry basis.

According to another aspect of the invention, there is provided a process for preparing a solution of calcium lignosulfonate optionally in admixture with an alkali metal lignosulfonate and/or alkaline earth metal lignosulfonate (preferably sodium and/or potassium and/or magnesium lignosulfonate), said process comprising
a) reacting a solution of ammonium lignosulfonate with a composition as defined hereinabove, optionally containing an alkali metal hydroxide and/or an alkaline earth metal hydroxide (preferably sodium hydroxide and/or potassium hydroxide and/or magnesium hydroxide);
b) steam stripping the solution obtained in step (a), and removing ammonia therefrom; so as to obtain said solution of calcium lignosulfonate optionally containing alkali metal lignosulfonate and/or alkaline earth metal lignosulfonate (preferably sodium and/or potassium and/or magnesium lignosulfonate);
c) adding an acid to said solution obtained from step (b) so as to adjust the pH;
d) removing calcium sulphate from said solution obtained from step (c);
e) cooling the said solution obtained from step (d).

According to another aspect of the invention, there is provided a process as defined hereinabove wherein the alkali metal hydroxide is under the form of an aqueous solution having a sodium hydroxide and/ or potassium hydroxide content of 50% w/w.

According to another aspect of the invention, there is provided a process as defined hereinabove wherein the alkali metal hydroxide is reached with the ammonium lignosulfonate at a dosage between 0 and 20% w/w dry basis (upper limit included).

According to another aspect of the invention, there is provided a process as defined hereinabove wherein the alkaline earth metal hydroxide is under the form of an aqueous slurry solution having a magnesium hydroxide content of 40-50% w/w.

According to another aspect of the invention, there is provided a process as defined hereinabove wherein the alkaline metal hydroxide is reacted with the ammonium lignosulfonate at a dosage between 0 and 20% w/w dry basis (upper limit included).

According to another aspect of the invention, there is provided a process as defined hereinabove wherein the calcium hydroxide slurry composition is reacted with the ammonium lignosulfonate at a dosage of 0.1-20% w/w dry basis.

According to another aspect of the invention, there is provided a process as defined hereinabove wherein steam is injected in step (a) so that the solution of ammonium lignosulfonate is reacted solution with a composition as defined hereinabove, optionally containing an alkali metal hydroxide and/or an alkaline earth metal hydroxide, at a temperature of 90 to 130° C. More preferably, the temperature may be of about 112° C.

According to another aspect of the invention, there is provided a process for preparing a solution of calcium lignosulfonate optionally containing alkali metal lignosulfonate and/or alkaline earth metal hydroxide lignosulfonate (preferably sodium and/or potassium and/or magnesium lignosulfonate), said process comprising:
a) carrying out a process as defined in any one of claims hereinbefore, so as to obtain a calcium hydroxide slurry composition;
b) reacting ammonium lignosulfonate solution together with a calcium hydroxide slurry composition as obtained in step (a), and optionally with a solution of an alkali metal hydroxide and/or an alkaline earth metal hydroxide (preferably sodium hydroxide and/or potassium hydroxide and/or magnesium hydroxide);
c) steam stripping the solution obtained in step (b) to substantially remove ammonia therefrom, so as to obtain said calcium solution optionally further containing alkali metal lignosulfonate and/or alkaline earth metal hydroxide lignosulfonate (preferably sodium and/or potassium and/or magnesium lignosulfonate);
d) adding an acid to said solution obtained in step (c) so as to adjust the pH;
e) removing calcium sulphate from said solution obtained in step (d);
f) cooling the said solution obtained in step (e).

According to another aspect of the invention, in the above mentioned process the alkali metal hydroxide is advantageously under the form of an aqueous solution having a sodium hydroxide and/or potassium hydroxide content of 50% w/w.

According to another aspect of the invention, in the above mentioned process the alkaline earth metal hydroxide is advantageously under the form of an aqueous slurry solution having a magnesium hydroxide content of 40-50% w/w.

According to another aspect of the invention, in the above mentioned process the alkaline metal hydroxide is advantageously reached with the ammonium lignosulfonate at a dosage between 0 and 20% w/w dry basis (upper limit included).

According to another aspect of the invention, in the above mentioned process the calcium hydroxide slurry composition is advantageously reached with the ammonium lignosulfonate at a dosage of 0.1-20% w/w dry basis.

According to another aspect of the invention, in the above mentioned process steam is injected in step (b) so that the solution of ammonium lignosulfonate solution is reached with a composition as defined hereinabove, optionally containing an alkali metal hydroxide and/or an alkaline earth metal hydroxide at a temperature of about 90 to about 130° C. More preferably, the temperature may be of about 112° C.

According to another aspect of the invention, in the above mentioned process the pH is adjusted at a value of about 4.0 to about 9.0, more preferably at a value of about 5.0 to about 6.0.

According to another aspect of the invention, in the above mentioned process the acid is advantageously selected from the group consisting of higher than 25% w/w solids sulfuric acid, acetic acid, formic acid, aluminum sulfate and nitric acid

According to another aspect of the invention, in the above mentioned process gypsum is advantageously removed by centrifugation at 80° C.

According to another aspect of the invention, in the above mentioned process the said solution of calcium lignosulfonate optionally containing sodium and/or potassium and/or magnesium lignosulfonate is cooled to below 60° C.

According to another aspect of the invention, in the above mentioned process said ammonium lignosulfonate solution has advantageously a concentration of solids of about 45 to about 55% w/w.

According to another aspect of the invention, in the above mentioned process said solution of calcium lignosulfonate optionally containing sodium and/or potassium and/or magnesium lignosulfonate has a concentration of solids of at least 40% w/w, preferably of at least 45% w/w and more preferably of at least 50% w/w. According to a particularly preferred embodiment of the invention, said solution of calcium lignosulfonate optionally containing sodium and/or potassium and/or magnesium lignosulfonate has a concentration of solids of about 40 to about 55% w/w, more preferably of about 45 to about 55% w/w.

According to another aspect of the invention, in the above mentioned process said solution of calcium lignosulfonate optionally containing sodium and/or potassium and/or magnesium lignosulfonate has advantageously a concentration of soluble sulfate that is less than 2.0% wt/wt dry basis.

According to another aspect of the invention, there is provided a process for preparing a low sulfate alkali metal, alkaline earth metal ammonium or mixture thereof lignosulfonate solution (preferably low sulfate sodium, potassium, magnesium, ammonium or a mixture thereof lignosulfonate solution) comprising:
a) carrying out a process as defined hereinabove, so as to obtain a calcium hydroxide slurry composition;
b) reacting a sulfate containing alkali metal, alkaline earth metal ammonium or mixture thereof lignosulfonate solution (preferably sodium, potassium, magnesium, ammonium or a mixture thereof lignosulfonate with calcium hydroxide slurry obtained in step (a) to obtain a solution of low sulfate alkali metal, alkaline earth metal ammonium or mixture thereof lignosulfonate solution (preferably low sulfate sodium, potassium, magnesium, ammonium or a mixture thereof lignosulfonate solution); and
c) removing calcium sulphate from said solution obtained in step (b).

According to another aspect of the invention, in the process defined hereinabove, the calcium hydroxide is added to the said sodium, potassium, magnesium, ammonium or mixture thereof lignosulfonate at a dosage of 0.1-10% w/w dry basis.

According to another aspect of the invention, in the process defined hereinabove, the calcium sulfate defines gypsum that is removed by centrifugation at 80 C.

According to another aspect of the invention, in the process defined hereinabove, said low sulfate sodium, potassium, magnesium, ammonium or a mixture thereof lignosulfonate solution has advantageously a concentration of solids of at least 40% w/w, more advantageously a concentration of solids of at least 45% w/w and much more advantageously a concentration of solids of about 45 to about 55% w/w. According to a particularly preferred aspect of the invention in the process defined hereinabove, said low sulfate sodium, potassium, magnesium, ammonium or a mixture thereof lignosulfonate solution has a concentration of solids of at least 45% w/w, preferably a concentration of solids of at least 50% w/w, more preferably a concentration of solids of about 40 to about 55% w/w and much more preferably a concentration of solids of about 45 to about 55% w/w

According to another aspect of the invention, in the process defined hereinabove, said sodium, potassium, magnesium, ammonium or a mixture thereof lignosulfonate solution has a concentration of soluble sulfate that is less than 2.0% w/w dry basis.

According to another aspect of the invention, there is provided a low sulfate alkali metal, alkaline earth metal ammonium or mixture thereof lignosulfonate solution (preferably low sulfate sodium, potassium, magnesium, ammonium or a mixture thereof lignosulfonate solution) obtained by the process defined hereinabove.

According to another aspect of the invention, there is provided a use of a process as defined hereinabove within the field of the present invention, for treating a weak liquor originating from pulp and paper industry.

According to another aspect of the invention, there is provided a use of a salt of a lignosulfonic acid as a dispersant in a calcium hydroxide slurry.

According to another aspect of the invention, there is provided a use of an alkali metal salt of a lignosulfonic acid or an alkaline earth metal salt of lignosulfonic acid as a dispersant in a calcium hydroxide slurry. Preferably, the dispersant is selected from the group consisting of sodium lignosulfonate, potassium lignosulfonate, magnesium lignosulfonate and mixtures thereof.

According to another aspect of the invention, there is provided a composition whenever obtained by a process as defined hereinbefore within the field of the invention.

According to another aspect of the invention, there is provided a solution of calcium lignosulfonate optionally containing sodium and/or potassium and/or magnesium lignosulfonate solution whenever obtained by a process as defined hereinbefore within the field of the invention.

According to another aspect of the invention, there is provided a fluidizing additive for cement or concrete comprising a lignosulfonate solution whenever obtained by a process as defined hereinbefore within the field of the invention.

Applicant has found that the latter five steps permit to prepare a solution of calcium lignosulfonate or a mixture of calcium and sodium and/or potassium and/or magnesium lignosulfonate solution in a simple and efficient manner at low costs. These processes permit to prepare a solution of calcium lignosulfonate or a mixture of calcium and sodium and/or potassium and/or magnesium lignosulfonate solution which has a higher than 45% w/w solids concentration. Thus, the use of an evaporator to concentrate the desired solution can be avoided, thereby considerably lowering the costs of production of a solution of calcium lignosulfonate or a mixture of calcium and sodium and/or potassium and/or magnesium lignosulfonate solution

The dispersant in the present invention can be a salt of a lignosulfonic acid. Preferably the dispersant is an alkali metal salt of a lignosulfonic acid. The alkali metal salt of lignosulfonic acid can be selected from the group consisting of sodium lignosulfonate, potassium lignosulfonate, and mixtures thereof. Alternatively, the dispersant can be an alkaline earth metal salt of a lignosulfonic acid. The alkaline earth metal salt of lignosulfonic acid is preferably selected from the group consisting of magnesium lignosulfonate. In the composition of the present invention the dispersant is preferably present in an amount of about 0.2 to about 7.5% w/w dry basis. The composition of the present invention can be useful for preparing a solution of calcium lignosulfonate or a mixture of calcium and sodium and/or potassium and/or magnesium lignosulfonate solution or for converting ammonium lignosulfonate into calcium lignosulfonate or into a mixture of calcium and sodium and/or potassium and/or magnesium lignosulfonate that contains less than 2.0% w/w of soluble sulfate.

In addition, the composition can be useful for preparing higher than 45% w/w solids and less than 2.0% w/w dry basis sulfate, sodium, potassium, ammonium or magnesium lignosulfonates by reacting the said composition with these lignosulfonates and removing the gypsum solids by centrifugation.

In the process for preparing the composition of the invention, the dispersant, water and calcium hydroxide can be mixed together at a temperature of about 25 to about 100° C., and preferably of about 60 to about 100° C.

In the process for preparing a lime slurry according to the invention, the calcium hydroxide can be added in an amount of about 0.2 to about 7.5% w/w. The lime slurry can have preferably a concentration of solids higher than 30% w/w, advantageously in an amount higher than 40% w/w and preferably in an amount comprised between 40.0 to about 55.0% w/w. Alternatively, the lime slurry can have a concentration of solids of about 40 to about 50%. The lime slurry preferably has a viscosity below 2000 cps, more preferably below 1000 cps. According to a particularly preferred aspect of the invention, the lime slurry according to the invention has a viscosity below 500 cps and more preferably between 10 and 500 cps. The dispersant can be any one of the dispersant as previously defined.

In the processes for preparing a solution of calcium lignosulfonate or a mixture of calcium and sodium and/or potassium and/or magnesium lignosulfonate solution the ammonium lignosulfonate solution can have a concentration of solids of at least 10% w/w. Preferably, the ammonium lignosulfonate solution has a concentration of solids of about 35 to about 55% w/w. The calcium lignosulfonate or a mixture of calcium and sodium and/or potassium and/or magnesium lignosulfonate solution can have a concentration of solids of at least 35% w/w, preferably at least 40% w/w, and more preferably at least 45% w/w. A concentration of at least 50% w/w is preferred. Alternatively, the solution of calcium lignosulfonate or a mixture of calcium and sodium and/or potassium and/or magnesium lignosulfonate solution can have a concentration of solids of about 40 to about 55% w/w and preferably of about 45 to about 55% w/w.

In the processes for preparing a solution of calcium lignosulfonate or a mixture of calcium and sodium and/or potassium and/or magnesium lignosulfonate solution steam can be injected when reacting together ammonium lignosulfonate, the optional alkali metal hydroxide and/or alkaline earth metal hydroxide and the composition or lime slurry according to the invention. In this step the temperature is about 90 to about 130° C. Preferably, the temperature is about 112° C. After ammonia stripping, the pH can be adjusted at a value of about 4.0 to about 9.0, and preferably at about 5.0 to about 6.0. The acid is preferably selected from the group consisting of higher than 25% w/w sulfuric acid, acetic acid, formic acid aluminum sulfate and nitric acid. Preferably, they can be used for treating a weak liquor originating from a pulp and paper industry. In fact, these processes permit the valorization of the weak liquor by converting the ammonia lignosulfonate contained therein into a calcium lignosulfonate or a mixture of calcium and sodium and/or potassium and/or magnesium lignosulfonate solution that contains less than 2.0% w/w soluble sulfate.

A fluidizing additive for cement or concrete comprising a lignosulfonate solution whenever obtained by a process as defined hereinbefore.

### DESCRIPTION OF PREFERRED EMBODIMENTS

Further features and advantages of the invention will become more readily apparent from the following description of preferred embodiments as illustrated by way of examples in the appended drawings wherein:

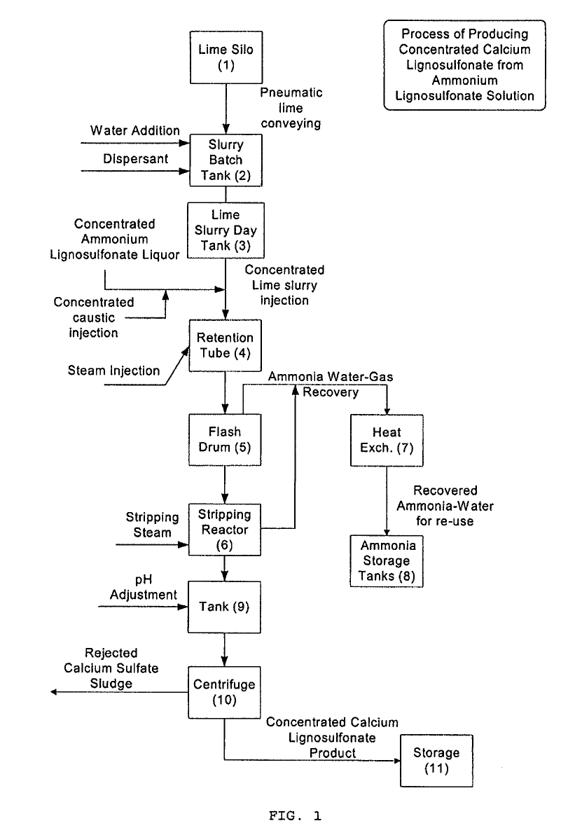

FIG. 1 shows a flow chart diagram of a process for preparing a calcium lignosulfonate solution according to a preferred embodiment of the invention;

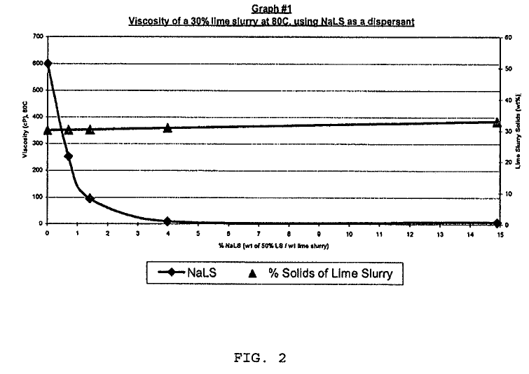

FIG. 2 shows that adding 4% in weight addition of 50% w/wsodium lignosulfonate, reduces the viscosity of a 30% w/w solids lime slurry from 600 to 10 cP at 80 C. (Graph #1);

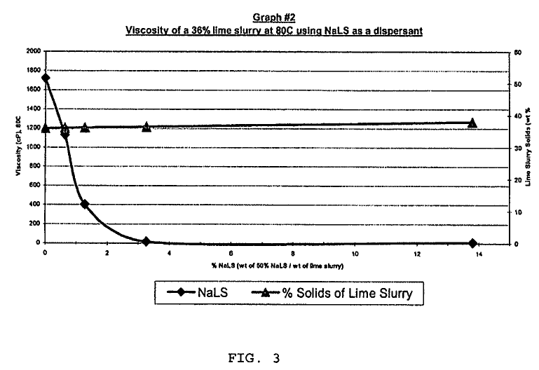

FIG. 3 shows that adding 3.3% in weight addition of 50% w/w sodium lignosulfonate reduces the viscosity of a 36% w/w solids lime slurry from 1720 to 15 cP at 80 C. (Graph #2); and

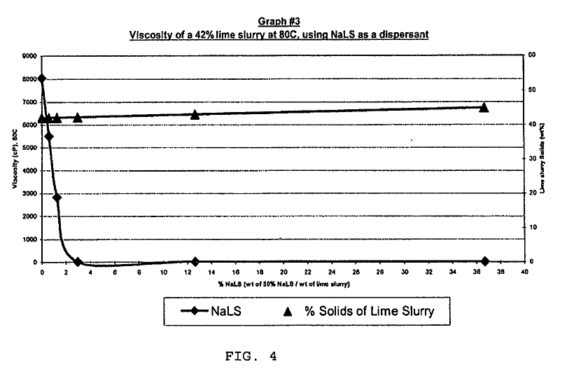

FIG. 4 shows shows that adding 3.0% in weight addition of 50% w/w sodium lignosulfonate reduces the viscosity of a 42% w/w solids lime slurry from 8050 to 15 cP at 80 C. (Graph #3).

FIG. 1 shows a flow chart diagram which illustrates a process according to the present invention. More particularly, Lime Silo (1) is used for storing hydrated lime. During lime slurry makeup, hot water and dispersant are added to Slurry Batch Tank (2). After mixing of the dispersant and hot water, the lime is conveyed from the silo to the Lime Slurry Batch Tank (2). Concentrated lime slurry is transferred to the Lime Slurry Day Tank (3). During calcium lignosulfonate manufacturing, alkali metal hydroxide and lime slurry are added to concentrated ammonium lignosulfonate. Steam is injected into the Retention Tube (4) which is a pre-reaction vessel. Ammonia from ammonium lignosulfonate is partially removed from liquid lignosulfonate in Flash Drum (5). The ammonia stripping polishing step occurs in Stripping Reactor (6). Ammonia gas from steam stripping process is condensed in Heat Exchanger (7) and recovered in Ammonia Storage Tanks (8). Calcium lignosulfonate product is transferred from the Reactor to Tank (9) where the pH is adjusted. The liquid is then pumped to a decanter centrifuge (10) to remove gypsum suspended solids. Concentrated calcium lignosulfonate product is stored in Product storage tank (11).

### EXAMPLES

### Example 1

Graphs 1,2 and 3 illustrate the effect of adding Sodium lignosulfonate dispersant to lime slurry. In these examples, 50% w/w sodium lignosulfonate solution was added to 80° C. water. After dilution, dry hydrated lime was added to make up lime slurry solutions from 30 to 42% w/w (dry lime/lime+water).

A 4% addition of 50% sodium lignosulfonate reduces the viscosity of a 30% w/w solids lime slurry from 600 to 10 cP at 80 C. (Graph #1).

A 3.3% addition of 50% w/w sodium lignosulfonate reduces the viscosity of a 36% w/w solids lime slurry from 1720 to 15 cP at 80° C. (Graph #2).

A 3.0% addition of 50% sodium lignosulfonate reduces the viscosity of a 42% w/w solids lime slurry from 8050 to 15 cP at 80° C. (Graph #3).

### Example 2

In this example, a calcium lignosulfonate (wt Ca ion/Ca+Na ions was 60%) was manufactured.

The flow chart diagram of FIG. 1 still applies to the present example.

A lime slurry was made up as in Example 1. The recipe was:

| | |
|---|---|
| 50% w/w sodium lignosulfonate | 11.5 wt % |
| Dry Lime | 42.4 wt % |
| Hot water | 46.1 wt % |

The combined solids of this solution were 48.2% w/w. The viscosity was 50 cP at 65° C.

52% ammonium lignosulfonate at a temperature of 95 C was reacted with 3.3% causic (dry basis) followed by the addition of lime slurry at 11.5% w/w lime (dry basis).

In the Retention Tube and Reactor the ammonia gas is steam stripped from the liquid. Finished product calcium lignosulfonate was pH adjusted from 9.0 to 5.5 by the addition of aluminum sulphate and sulphuric acid. Addition of acid decreases the viscosity of calcium lignosulfonate. As well, the addition of acid prevents viscosity increase in finished product over time. Further, decreasing the pH to 5.5 prevents growth of bacteria in this product during transport and storage.

The gypsum suspended solids are removed from calcium lignosulfonate by using a decanter centrifuge. The finished product is then cooled to at least 60° C. to prevent viscosity increase with time. The raw material and finished product properties are:

| | Ammonium | Calcium |
|---|---|---|
| | lignosulfonate | lignosulfonate |
| | (raw material) | (finished product) |
| pH | 4.5 | 5.5 |
| Solids wt % | 52 | 48 |
| Viscosity (cP) | 600 | 500 |
| Free Nitrogen wt %, dry basis | 4.5 | 0.4 |
| Sulfate wt %, dry basis | 5 | 0.8 |

By this process, 48.2% solids lime slurry is used to manufacture 48% solids calcium lignosulfonate.

### Example 3

Table 1 shows performance in concrete of the products manufactured in Example 2. (60% Ca/Ca+Na ion calcium lignosulfonate) Three different samples show very good fluidity (140-150 mm), low air (2.4 to 2.5% air) and increased strength versus control that does not contain lignosulfonate.

In another example of process, a 10% Ca/Ca+Na ion, sodium lignosulfonate was manufactured by adding a dosage of 8.6% w/w dry caustic and 6.2% w/w dry lime to ammonium lignosulfonates. Table 1 shows performance in concrete of these products. Three different samples show good fluidity (120-150 mm), low air entrainment (2.4 to 2.8%) and high strength at 7 and 28 day versus control that does not contain lignosulfonate.

TABLE 1
Results from concrete testing
(363 kg cement/m³, 0.15% LS, w/c 0.505)

| | | |
|---|---|---|
| Air | | Compressive |
| entrained | Slump | strength (Mpa) |

| Sample | (vol %) | (mm) | 7 day | 28 day |
|---|---|---|---|---|
| 10% Ca LS-01 | 2.8 | 120 | 36.9 | 46.1 |
| 10% Ca LS-02 | 2.5 | 125 | 37.9 | 45.4 |
| 10% Ca LS-03 | 2.4 | 150 | 36.5 | 44.5 |
| 60% Ca LS-01 | 2.4 | 140 | 36.7 | 45.1 |
| 60% Ca LS-01 | 2.5 | 150 | 34.7 | 45.0 |
| 60% Ca LS-01 | 2.5 | 140 | 35.0 | 43.8 |
| Control (no LS) | 2.4 | 135 | 32.0 | 41.3 |

Control had a w/c ratio of 0.525

These products are salt tolerant, and are compatible with further additional dispersing agents such as polynaphtalene sulfonates, melamine sulfonates, polycarboxylates, and polyether type. The level of the dispersant in cement is within a range of 0.1 to 0.6% w/w.

It has thus been demonstrated that the compositions and lime slurries of the present invention have several advantages over the prior art since they can be easily manipulated even at higher than 30% w/w (preferably higher than 40% w/w) concentration. In fact, in view of the dispersant added therein, they can have a below 500 cP viscosity even if they have a higher than 30% w/w (preferably higher than 40% w/w) concentration of solids. Thus, these compositions or lime slurries can be pumped through conduits or pipes without settling. It has also been demonstrated that the processes for preparing such compositions or slurries are simple and they permit to considerably reduce the costs of calcium lignosulfonate production mainly because they permit to obtained higher than 30% w/w (preferably higher than 40% w/w) concentration compositions or lime slurries, thereby avoiding the an evaporation step. Moreover, they can also permit to reduce the costs related to transportation of calcium lignosulfonate that has a 45-55% solids.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

What is claimed is:

1. A calcium hydroxide slurry composition comprising:

| | | |
|---|---|---|
| calcium hydroxide | >30% | w/w |
| a dispersant, said dispersant being a salt of | ≧0.2% | w/w |
| lignosulfonic acid; | | |
| water | qsp 100% | w/w |

2. A calcium hydroxide slurry composition according to claim 1, wherein it comprises:
40.0 to 55.0% w/w of calcium hydroxide.
0.2 to 7.5% w/w of a dispersant, said dispersant being a salt of a lignosulfonic acid; and
37.5 to 59.8% w/w of water.

3. A calcium hydroxide slurry composition according to claim 1, wherein it comprise:
45.0 to 50.0% w/w of calcium hydroxide.
0.2 to 7.5% w/w of a dispersant, said dispersant being a salt of a lignosulfonic acid; and
42.5 to 54.8% w/w of water.

4. A composition according to claim 1, wherein said composition has a concentration of solids of 45 to 55% w/w.

5. A composition according to claim 4, wherein said composition has a viscosity below 2000 cps.

6. A composition according to claim 5, wherein said composition has a viscosity below 1000 cps.

7. A composition according to claim 6, wherein said composition has a viscosity below 500 cps.

8. A composition according to claim 7, wherein said composition has a viscosity between 10 and 500 cps

9. A composition according to claim 4, wherein said dispersant is an alkali metal salt of a lignosulfonic acid.

10. A composition according to claim 4, wherein the dispersant is selected from the group consisting of sodium lignosulfonate, potassium lignosulfonate, and mixtures thereof.

11. A composition according to claim 4, wherein said dispersant is an alkaline earth metal salt of a lignosulfonic acid.

12. A composition according to claim 4, wherein said dispersant is magnesium lignosulfonate.

13. A process for preparing a composition as defined in claim 1, said process comprising a step of admixing together the dispersant, water and calcium hydroxide.

14. A process according to claim 13, wherein the dispersant, water and calcium hydroxide are mixed together at a temperature of 25 to 100° C.

15. A process according to claim 13, wherein said calcium hydroxide slurry has a concentration of solids of about 40 to about 55% w/w.

16. A process according to claim 13, wherein said dispersant is selected from the group consisting of alkali metal salt of a lignosulfonic acid, alkaline earth metal salt of a lignosulfonic acid and mixture thereof.

17. A process according to claim 16, wherein the alkali metal salt of lignosulfonic acid is selected from the group consisting of sodium lignosulfonate, potassium lignosulfonate, magnesium lignosulfonate and mixtures thereof.

18. A process for preparing a solution of calcium lignosulfonate optionally in admixture with an alkali metal lignosulfonate and/or alkaline earth metal lignosulfonate (preferably sodium and/or potassium and/or magnesium lignosulfonate), said process comprising a step of reacting ammonium lignosulfonate solution with
0.1-20% by weight of calcium hydroxide slurry composition as defined in claim 1 optionally further containing between 0-20% by weight (upper limit included) of an alkali metal hydroxide and/or an alkaline earth metal hydroxide (preferably sodium hydroxide and/or potassium hydroxide and/or magnesium hydroxide); or
optionally 0.1-20% by weight of calcium hydroxide slurry composition and a solution comprising between 0-20% (upper limit included) by weight of an alkali metal hydroxide and/or an alkaline earth metal hydroxide (preferably sodium hydroxide and/or potassium hydroxide and/or magnesium hydroxide).

19. A process according to claim 18, wherein said ammonium lignosulfonate solution has a concentration of solids of about 45 to about 55% w/w.

20. A process according to claim 18, wherein said solution of calcium lignosulfonate optionally in admixture with sodium and/or potassium and/or magnesium lignosulfonate has a concentration of solids of at least 35% w/w.

21. A process according to claim 18 wherein said solution of calcium lignosulfonate optionally in admixture with sodium and/or potassium and/or magnesium lignosulfonate solution has a concentration of solids of about 45 to about 55% w/w.

22. A process according to claim 18, wherein said solution of calcium lignosulfonate optionally in admixture with sodium and/or potassium and/or magnesium lignosulfonate has a concentration of soluble sulfate that is less than 2.0% w/w dry basis.

23. A process for preparing a solution of calcium lignosulfonate optionally in admixture with an alkali metal lignosulfonate and/or alkaline earth metal lignosulfonate (preferably sodium and/or potassium and/or magnesium lignosulfonate), said process comprising
a) reacting a solution of ammonium lignosulfonate with a composition as defined in claim 1, optionally containing an alkali metal hydroxide and/or an alkaline earth metal hydroxide (preferably sodium hydroxide and/or potassium hydroxide and/or magnesium hydroxide);
b) steam stripping the solution obtained in step (a), and removing ammonia therefrom; so as to obtain said solution of calcium lignosulfonate optionally containing alkali metal lignosulfonate and/or alkaline earth metal lignosulfonate (preferably sodium and/or potassium and/or magnesium lignosulfonate);
c) adding an acid to said solution obtained from step (b) so as to adjust the pH;
d) removing calcium sulphate from said solution obtained from step (c);
e) cooling the said solution obtained from step (d).

24. A process according to claim 23, wherein the alkali metal hydroxide is under the form of an aqueous solution having a sodium hydroxide and/or potassium hydroxide content of 50% w/w.

25. A process according to claim 23, wherein the alkali metal hydroxide is reached with the ammonium lignosulfonate at a dosage between 0 and 20% w/w dry basis (upper limit included).

26. A process according to claim 23, wherein the alkaline earth metal hydroxide is under the form of an aqueous slurry solution having a magnesium hydroxide content of 40-50% w/w.

27. A process according to claim 23, wherein the alkaline metal hydroxide is reacted with the ammonium lignosulfonate at a dosage between 0 and 20% w/w dry basis (upper limit included).

28. A process according to claim 23, wherein the calcium hydroxide slurry composition is reacted with the ammonium lignosulfonate at a dosage of 0.1-20% w/w dry basis.

29. A process for preparing a solution of calcium lignosulfonate optionally in admixture with an alkali metal lignosulfonate and/or alkaline earth metal lignosulfonate (preferably sodium and/or potassium and/or magnesium lignosulfonate), said process comprising:
a) reacting a solution of ammonium lignosulfonate with a composition as defined in claim 1, optionally containing an alkali metal hydroxide and/or an alkaline earth metal hydroxide (preferably sodium hydroxide and/or potassium hydroxide and/or magnesium hydroxide), steam being further injected in step (a) so that the reaction is carried out at a temperature of 90 to 130° C.;
b) steam stripping the solution obtained in step (a), and removing ammonia therefrom; so as to obtain said solution of calcium lignosulfonate optionally containing alkali metal lignosulfonate and/or alkaline earth metal lignosulfonate (preferably sodium and/or potassium and/or magnesium lignosulfonate);
c) adding an acid to said solution obtained from step (b) so as to adjust the pH;
d) removing calcium sulphate from said solution obtained from step (c);
e) cooling the said solution obtained from step (d).

30. A process for preparing a solution of calcium lignosulfonate optionally containing alkali metal lignosulfonate and/or alkaline earth metal hydroxide lignosulfonate (preferably sodium and/or potassium and/or magnesium lignosulfonate), said process comprising:
a) carrying out a process as defined in claim 13, so as to obtain a calcium hydroxide slurry composition;
b) reacting ammonium lignosulfonate solution together with a calcium hydroxide slurry composition as obtained in step (a), and optionally with a solution of an alkali metal hydroxide and/or an alkaline earth metal hydroxide (preferably sodium hydroxide and/or potassium hydroxide and/or magnesium hydroxide);
c) steam stripping the solution obtained in step (b) to substantially remove ammonia therefrom, so as to obtain said calcium solution optionally further containing alkali metal lignosulfonate and/or alkaline earth metal hydroxide lignosulfonate (preferably sodium and/or potassium and/or magnesium lignosulfonate);
d) adding an acid to said solution obtained in step (c) so as to adjust the pH;
e) removing calcium sulphate from said solution obtained in step (d);
f) cooling the said solution obtained in step (e).

31. A process according to claim 30, wherein the alkali metal hydroxide is under the form of an aqueous solution having a sodium hydroxide and/or potassium hydroxide content of 50% w/w.

32. A process according to claim 30, wherein the alkali metal hydroxide is reached with the ammonium lignosulfonate at a dosage between 0 and 20% w/w dry basis (upper limit included).

33. A process according to claim 30, wherein the alkaline earth metal hydroxide is under the form of an aqueous slurry solution having a magnesium hydroxide content of 40-50% w/w.

34. A process according to claim 30, wherein the alkaline metal hydroxide is reached with the ammonium lignosulfonate at a dosage between 0 and 20% w/w dry basis (upper limit included).

35. A process according to claim 30, wherein the calcium hydroxide slurry composition is reached with the ammonium lignosulfonate at a dosage of 0.1-20% w/w dry basis.

36. A process for preparing a solution of calcium lignosulfonate optionally containing alkali metal lignosulfonate and/or alkaline earth metal hydroxide lignosulfonate (preferably sodium and/or potassium and/or magnesium lignosulfonate), said process comprising:
a) carrying out a process as defined in claim 13, so as to obtain a calcium hydroxide slurry composition;
b) reacting ammonium lignosulfonate solution together with a calcium hydroxide slurry composition as obtained in step (a), and optionally with a solution of an alkali metal hydroxide and/or an alkaline earth metal hydroxide (preferably sodium hydroxide and/or potassium hydroxide and/or magnesium hydroxide), steam being injected in step (b) so that the reaction is carried out at a temperature of about 90 to about 130° C.;
c) steam stripping the solution obtained in step (b) to substantially remove ammonia therefrom, so as to obtain said calcium solution optionally further containing alkali metal lignosulfonate and/or alkaline earth metal hydroxide lignosulfonate (preferably sodium and/or potassium and/or magnesium lignosulfonate);
d) adding an acid to said solution obtained in step (c) so as to adjust the pH;
e) removing calcium sulphate from said solution obtained in step (d);
f) cooling the said solution obtained in step (e).

37. A process according to claim 30, wherein the pH is adjusted at a value of about 4.0 to about 9.0.

38. A process according to claim 37, wherein the pH is adjusted at a value of about 5.0 to about 6.0.

39. A process according to claim 30, wherein the acid is selected from the group consisting of higher than 25% w/w solids sulfuric acid, acetic acid, formic acid, aluminum sulfate and nitric acid

40. A process according to claim 30, wherein gypsum is removed by centrifugation at 80° C.

41. A process according to claim 30, wherein the said solution of calcium lignosulfonate optionally containing sodium and/or potassium and/or magnesium lignosulfonate is cooled to below 60° C.

42. A process according to claim 30, wherein said ammonium lignosulfonate solution has a concentration of solids of about 45 to about 55% w/w.

43. A process according to claim 30, wherein said solution of calcium lignosulfonate optionally containing sodium and/or potassium and/or magnesium lignosulfonate has a concentration of solids of at least 40% w/w.

44. A process according to claim 30, wherein said solution of calcium lignosulfonate optionally containing sodium and/or potassium and/or magnesium lignosulfonate has a concentration of solids of about 45 to about 55% w/w.

45. A process according to claim 30, wherein said solution of calcium lignosulfonate optionally containing sodium and/or potassium and/or magnesium lignosulfonate has a concentration of soluble sulfate that is less than 2.0% wt/wt dry basis.

46. A process for preparing a low sulfate alkali metal, alkaline earth metal ammonium or mixture thereof lignosulfonate solution (preferably low sulfate sodium, potassium, magnesium, ammonium or a mixture thereof lignosulfonate solution) comprising:
a) carrying out a process as defined in claim 1, so as to obtain a calcium hydroxide slurry composition;
b) reacting a sulfate containing alkali metal, alkaline earth metal ammonium or mixture thereof lignosulfonate solution (preferably sodium, potassium, magnesium, ammonium or a mixture thereof lignosulfonate with calcium hydroxide slurry obtained in step (a) to obtain a solution of low sulfate alkali metal, alkaline earth metal ammonium or mixture thereof lignosulfonate solution (preferably low sulfate sodium, potassium, magnesium, ammonium or a mixture thereof lignosulfonate solution); and
c) removing calcium sulphate from said solution obtained in step (b).

47. A process according to claim 46, wherein the calcium hydroxide is added to the said sodium, potassium, magnesium, ammonium or mixture thereof lignosulfonate at a dosage of 0.1-10% w/w dry basis.

48. A process according to claims 46, wherein the calcium sulfate defines gypsum that is removed by centrifugation at 80 C.

49. A process according to claim 46, wherein said low sulfate sodium, potassium, magnesium, ammonium or a mixture thereof lignosulfonate solution has a concentration of solids of about 45 to about 55% w/w.

50. A process according to claim 46, wherein said low sulfate sodium, potassium, magnesium, ammonium or a mixture thereof lignosulfonate solution has a concentration of solids of at least 40% w/w.

51. A process according to claim 46, wherein said low sulfate sodium, potassium, magnesium, ammonium or a mixture thereof lignosulfonate solution has a concentration of solids of about 45 to about 55% w/w

52. A process according to claim 46, wherein said sodium, potassium, magnesium, ammonium or a mixture thereof lignosulfonate solution has a concentration of soluble sulfate that is less than 2.0% w/w dry basis.

53. A solution of calcium lignosulfonate optionally containing sodium and/or potassium and/or magnesium lignosulfonate solution whenever obtained by the process defined in claim 24.

54. A low sulfate alkali metal, alkaline earth metal ammonium or mixture thereof lignosulfonate solution (preferably low sulfate sodium, potassium, magnesium, ammonium or a mixture thereof lignosulfonate solution) obtained by the process defined in claim 46.

55. A fluidizing additive for cement or concrete comprising a lignosulfonate solution whenever obtained by a process as defined in claim 24.
